(19) United States
(12) Patent Application Publication
(10) Pub. No.: US 2004/0012556 A1
(43) Pub. Date: Jan. 22, 2004

(54) Method and related device for controlling illumination of a backlight of a liquid crystal display

(76) Inventors: Sea-Weng Yong, Ping-Tung Hsien (TW); Chih-Chiang Huang, Taipei City (TW); Yi-Hsien Lee, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,459

(22) Filed: Jul. 17, 2002

(51) Int. Cl. G09G 3/36

(52) U.S. Cl. 345/102

(57) ABSTRACT

A method and device for controlling the illumination of a backlight of an LCD includes a light sensor that generates an ambient light intensity value, a processor that interprets the measured ambient light intensity value, a light source that is controlled by the processor, and an LCD device that is illuminated by the light source. The processor first calculates a light source intensity value based on a user-adjustable desired apparent light source brightness value and the measured ambient light intensity value. The processor then triggers the light source to emit light at a time-averaged intensity, utilizing frequency variation or a varying duty cycle, which corresponds to the calculated light source intensity value, such that the LCD device is illuminated. In this way, the information displayed on the LCD is clearly visible to a user in any ambient lighting condition.

### BACKGROUND OF INVENTION

1. Field of the Invention

The present invention relates to a Liquid Crystal Display (LCD), and more specifically to a method and related device for controlling illumination of a backlight of an LCD.

2. Description of the Prior Art

LCDs are common devices found in a wide variety of modern electronics. An LCD that is illuminated by a backlight can provide information to a user that is clearly visible in both light and dark ambient conditions. Mobile phones and personal digital assistants (PDAs) are two examples of popular consumer electronic devices that typically employ this kind of backlit LCD.

In the prior art, there are two main methods of adjusting the backlight illumination of an LCD. The first is a purely manual method where a user adjusts the backlight intensity when desired. This is the method that is commonly used in mobile phones and PDAs. The second method employs a photodiode to measure ambient light and trigger the backlight of the LCD accordingly.

A block diagram of a circuit realizing this second method is shown in FIG. 1. The backlight circuit 10 is used to ensure readability of an LCD module 20 in both bright and dark ambient light conditions. The backlight circuit 10 shows ambient light 12 being detected by a photodiode 14. The photodiode 14 outputs a current signal. The photodiode 14 is connected to a current-voltage (I/V) converter 16, which accepts the current signal and outputs a voltage signal to a comparator 18. The comparator 18 compares the voltage signal to a fixed reference level voltage 18r and illuminates an LCD backlight 20a accordingly to ensure that an appropriate amount of light is available to illuminate an LCD 20b. If the voltage signal is below the fixed reference level 18r, meaning that the ambient light 12 is dim, the comparator 18 outputs a constant illumination voltage to turn on the LCD backlight 20a. Conversely, the comparator 18 does not output the illumination voltage if the ambient light 12 is bright and voltage signal is consequently above the fixed reference level 18r. The LCD backlight 20 emits light 24 having a constant intensity, based on the constant illumination voltage, so that the LCD 20b is illuminated.

Essentially, the prior art method described detects if the ambient light 12 is dimmer than a threshold level and illuminates the LCD 22 accordingly. Consequently, this method does not provide enough flexibility to the user. For instance, the backlight 20 may be triggered when the LCD 22 is already bright enough to view, or the backlight 20 may remain off even when the intensity of the ambient light 12 is too low. Furthermore, if different users use the same device employing the prior art circuit 10, they may have differing opinions of the need for backlighting the LCD 22.

### SUMMARY OF INVENTION

It is therefore a primary objective of the claimed invention to provide a method and related device for controlling illumination of a backlight of an LCD to solve the problems of the prior art.

Briefly summarized, the preferred embodiment of the claimed invention provides a light sensor capable of measuring an ambient light intensity to generate a corresponding measured ambient light intensity value, a processor for interpreting the measured ambient light intensity value, a memory for storing information required by the processor, a light source that is controllable by the processor, and an LCD device capable of being illuminated by the light source. The processor first calculates a light source intensity value based on a user-adjustable desired apparent light source brightness value and the measured ambient light intensity value. The processor then triggers the light source to emit light at a time-averaged intensity that corresponds to the calculated light source intensity value, such that the LCD device is illuminated.

It is an advantage of the claimed invention that a user can specify the desired apparent light source brightness value so that the LCD device illumination compensates for ambient light intensity. It is another advantage of the claimed invention that the user can store numerous differing values of the desired apparent light source brightness for convenient use in various circumstances.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a prior art circuit for adjusting the backlight of an LCD.

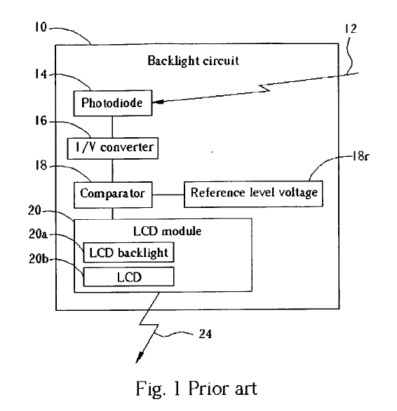

FIG. 2 is a block diagram of a circuit for adjusting the backlight of an LCD according to the preferred embodiment of the present invention.

FIG. 3 is a graph of five desired apparent light source brightness curves stored in the memory of FIG. 2.

FIG. 4 is a diagram of waveforms of digital illumination signals output by the processor of FIG. 2.

FIG. 5 is a block diagram of a circuit for adjusting the backlight of an LCD according to a second embodiment of the present invention.

### DETAILED DESCRIPTION

The present invention circuit and method are described as being employed in a mobile phone in a single embodiment. The present invention can also be used effectively in a wide assortment of other electronic devices comprising backlit LCD screens, such as personal data assistants (PDAs), pagers, etc.

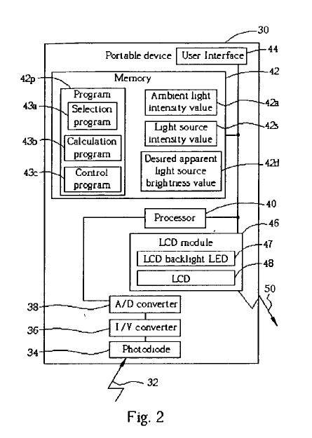

A block diagram of a portable device 30 according to the preferred embodiment of the present invention is shown in FIG. 2. A photodiode 34 is capable of outputting a current signal that is indicative of the intensity of ambient light 32, and is connected to a current-voltage (I/V) converter 36. The I/V converter 36 accepts the current signal output of the photodiode 34, and converts the current signal into a corresponding voltage signal. An analog to digital (A/D) converter 38 is provided connected to the I/V converter 36. The A/D converter 38 accepts the voltage signal output of the I/V converter 36, and converts the voltage signal into a digital signal. A processor 40 is connected to the A/D converter 38 and is able to accept and process the digital signal from the A/D converter 38. Attached to the processor 40 is a memory 42 that stores information required by the processor 40. In particular, the memory 42 contains a program 42p that is executed by the processor 40 to provide backlighting functionality of an LCD module 46 of the portable device 30. A user can manipulate the contents of the memory 42 through a user interface 44 to influence the operation of the processor 40. The user interface 44 is typically a keypad. The processor 40 outputs an illumination signal that is accepted by a connected LCD backlight 47, which is a light emitting diode (LED). The LED 47 emits light 50 at a time-averaged intensity according to the illumination signal output by the processor 40 such that an LCD 48 is illuminated. In the preferred embodiment, the illumination signal output by the processor 40 is a digital signal, and is described in more detail below. However, it should be clear that it is possible for the processor to generate an analog signal, perhaps by way of a digital-to-analog (D/A) converter, which is then fed to the LCD backlight LED 47. In either case, the time-averaged intensity of the LCD backlight LED 47 is controlled by the illumination signal provided by the processor 40.

The digital signal output by the A/D converter 38, and accepted by the processor 40, is represented in the processor 40 and the memory 42 as an ambient light intensity value 42a. The digital illumination signal fed to the LCD backlight LED 47 represents a light source intensity value 42s that is generated by the processor 40 based on the ambient light intensity value 42a and a desired apparent light source brightness value 42d.

Before the circuit 30 is fully functional, the desired apparent light source brightness value 42d (desired brightness value for short) must be stored in the memory 42. The desired brightness value 42d is normally specified by a user in advance, however, if one has not been specified a default, or preprogrammed, value can be used. The units of the desired brightness value can be a standard unit such as candle or lumen, but is preferably a unique unit of measure that can be intuitively understood by the typical user, such as an integer value scaled from zero to ten. Through the user interface 44, the user selects the desired brightness value 42d based on his or her preference with respect to viewing the LCD 48 in various ambient lighting conditions. The desired result being: no matter what the exact ambient lighting condition is, information displayed on the LCD 48 is clearly visible to the user.

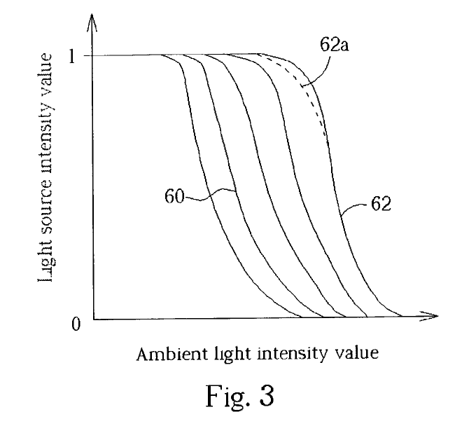

FIG. 3 shows a graph of light source intensity value (ordinate) with respect to ambient light intensity value (abscissa) for five desired apparent light source brightness values 42d represented by five unique curves. A greater or fewer number of curves could be used, and five curves are used here only as an example. These curves are digitally programmed into the memory 42, preferably in a nonvolatile portion, and can be manipulated by the user through the user interface 44. The exact shape of the five curves in FIG. 3 depends on a wide array of parameters such as the photodiode 34 type and quality, LCD 48 screen properties such as reflectivity and tint, and variety of the LED 47 used. For accuracy, the curves can be determined based on empirical data collected for a fully assembled mobile phone (or PDA) comprising the present invention. Alternatively, the curves could be represented within the memory 42 as mathematical functions parameterized by one or more input variables. In this case, each curve would then be represented by the unique set of parameter values that define the curve, and adjusting the curve would entail changing one or more of its representative input parameters.

Referencing a specific curve 60 having a unique desired brightness value, the curve 60 shows that the light source intensity value (which corresponds to the light source intensity value 42s that is sent to the LCD backlight LED 47) generally decreases with respect to increasing ambient light intensity value (which corresponds to the ambient light intensity value 42a, as measured by the photodiode 34). A value of 1 on the ordinate of FIG. 3 represents a digital illumination signal causing the LED 47 to be at full illumination, and a value of 0 on the ordinate represents the LED 47 as being off. The intermediate region of the ordinate (between 0 and 1) represents the LED 47 being illuminated by a variation of frequency or duty cycle so as to yield a time-averaged illumination intensity that lands between fully on and fully off. A higher desired brightness value (as indicated by desired apparent light source brightness value 42d) is represented by another curve 62, which also has the same general shape as the curve 60. A user wanting the LCD backlight 47 to be brighter would select the desired brightness value 42d corresponding to curve 62 over the desired brightness value 42d corresponding to curve 60. As the ambient lighting condition changes, the present invention circuit 30 automatically adjusts the light source intensity value 42s based on the selected desired brightness curve 42d, using the ambient light intensity value 42a as an input into the selected curve 42d to obtain the appropriate light source intensity value 42s. The family of curves shown in FIG. 3 and stored in the memory 42 can be customized by the user via the user interface 44.

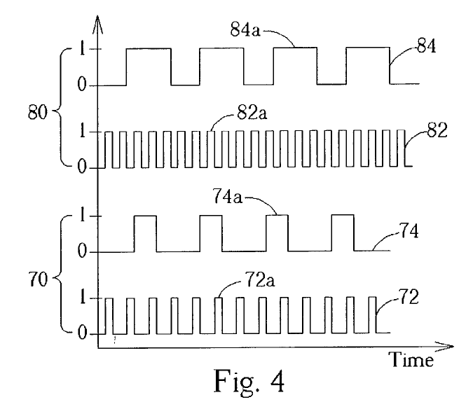

To achieve a brightness of the LED 47 according to an intermediate light source intensity value 42s based on the desired brightness value 42d and the ambient light intensity value 42a, the digital illumination signal must change over time. FIG. 4 shows four different digital illumination signals corresponding to two distinct light source intensity values 42s. Note that the ordinate shows values of 0 and 1 for each signal that correspond respectively to the LED 47 being fully off and fully on.

Digital illumination signals 72 and 74 provide for equal time-averaged intensity of the LED 47, and represent the same low light source intensity value 70. Digital illumination signals 82 and 84 also provide for equal time-averaged intensity of the LED 47, but represent a higher light source intensity value 80. The signals 72 and 82 are produced by changing the frequency at which the LED 47 is triggered. The brighter illumination signal 82 has a higher triggering frequency than the dimmer illumination signal 72. The shapes of the pulses 72a and 82a are the same. Only the frequency of the pulses 72a and 82a is changed to vary the brightness of the LED 47. Similarly, signals 84 and 74 represent a duty cycle method of illuminating the LED 47, which is the preferred embodiment method. The signals 84 and 74 have a common frequency, but different pulse durations. Pulse 84a is appreciably longer than pulse 74a and causes the signal 84 to trigger the LED 47 to illuminate at a time-averaged intensity than the signal 74. In practical applications, either of these methods of illuminating the LED 47, frequency variation or duty cycle, at values between off (0) and on (1), or even a combination of these methods, can be used to realize the present invention method. As noted earlier, it is also possible to provide the LED 47 with an analog signal such that the time-instantaneous intensity output of the LED 47 is the same as the time-averaged intensity output of the LED 47. Time averaging of the intensity of the LED 47 should be on the order of 1/20 of a second or shorter to avoid detection of flickering by the user.

To realize the previously describe functions, three programs form the program 42p. A selection program 43a linked to the user interface 44, a calculation program 43b comprising digital versions of the curves of FIG. 3, and a control program 43c to generate digital illumination signals similar to those illustrated in FIG. 4. The processor 40 then simply executes these programs 43a, 43b and 43c to provide the backlighting functionality of the LCD module 46.

Thus far, the relevant components of the present invention portable device 30 and method have been described, at this time the operation of the present invention will be explained. The user first activates the mobile phone (or PDA) comprising the present invention circuit. As shown in FIG. 2, ambient light 32 is received by the photodiode 34. The photodiode 34 outputs a current proportional to the intensity of the ambient light 32. This current signal is converted to a corresponding voltage signal by the I/V converter 36. The A/D converter 38 transforms this voltage signal into a digital signal. The processor 40, running the program 42p, accepts the digital signal and transforms it into an ambient light intensity value 42a. Meanwhile, via the user interface 44, the user has selected a desired apparent light source brightness value 42d, which is stored in the memory 42. This desired apparent light source brightness value 42d selects, and so is represented by, a curve as shown and discussed with FIG. 3 (such as the curve 60). The processor 40 uses the curve 60 to determine a light source intensity value 42s that corresponds to the measured ambient light intensity value 42a. The processor 40 then generates the digital illumination signal represented by the waveform 74 in FIG. 3, which corresponds to the light source intensity value 42s. The processor 40 outputs the signal 74 to the LED 47. The LED 47 is then illuminated (from the user“s perspective at the selected desired apparent light source brightness value 42d), and the user can now clearly view information displayed on the LCD 48.

If the ambient light condition changes while the user is viewing the LCD 48, say for example the user enters a darker room, the above-described method is repeated. In fact, the method is performed continuously as the user views the LCD 48, so that the time-averaged brightness of the LCD backlight LED 47 is constantly being adjusted for variations in ambient light intensity 42a. The speed of the processor 40 is the only practical limitation on how fast the present invention circuit can respond to changes in ambient light.

If the user decides the LCD backlight 47 is too dim, the user only has to manipulate the user interface 44 to increase the desired apparent light source brightness value 42d. This new higher desired brightness value 42d is represented by, for example, the curve 62 in FIG. 3. Now, as the ambient light intensity value 42a changes, the light source intensity value 42s is set according to the curve 62, and the overall brightness of the LCD backlight LED 47 is increased. In this way, the user can customize the operation of the present invention circuit 30. The desired brightness value 42d is preferably stored in a non-volatile memory so that it is not lost when the portable device 30 is turned off.

Another way the user can customize the behavior of the present invention circuit 30 is by modifying the shapes of the desired brightness value curves shown in FIG. 3. As previously described, the shapes of these curves are empirically determined as they depend on a multitude of factors. Suppose that the user has specified a desired brightness value corresponding to the curve 62. If the user finds that the LCD backlight 47 is too bright for some conditions but bright enough in other conditions, the user can adjust the curve 62 through the user interface 44. The middle part of the curve 62 would then be replaced by a curve portion 62a. To make this as user friendly as possible, the user interface can employ a fuzzy-logic system that would simply accept user feedback regarding the current brightness of the LCD backlight LED 46 and adjust the curve 62 to accordingly. Such adjustments may entail changing parameterizations of the curves, or by changing the location of sample data points of the curves, depending on how the curves are stored and represented in the memory 42.

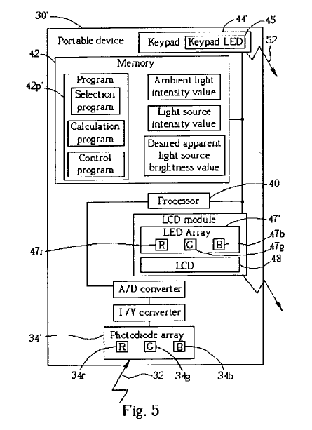

The present invention circuit and method can be extended in a second embodiment, which is detailed in FIG. 5 as portable device 30″. Rather than the single photodiode, photodiodes sensitive to different frequencies of light are provided in an array of photodiodes 34″. The photodiode array 34″ comprises photodiodes 34r, 34g, and 34b respectively sensitive to red, green, and blue light. Accordingly, an LED array 47″, each LED-47r, 47g, and 47b, respectively capable of emitting red, green, and blue light is provided to illuminate the LCD 48. The processor 40 and memory 42 function to generate a plurality of digital illumination signals, one for each LED 47r, 47g, and 47b. Accordingly, the program 42p” stored in the memory functions with the photodiodes 34r, 34g, and 34b and the LEDs 47r, 47g, and 47b. The resulting effect is that the LCD 48 is illuminated to compensate not only for a varying intensity of the ambient light 32, but also for a varying color of the ambient light 32. This embodiment of the present invention allows an LCD 48 on a mobile phone to be clearly viewed by a user in a halogen-lit office, in an incandescently illuminated home, and at a restaurant having dim colored light, all with minimal user effort. In practical application, the specific frequencies of ambient light addressed (red, green, and blue being used only for illustrative purposes) are determined referencing the intended use of the portable device 30″, photodiode and LED availability, and other design concerns.

The second embodiment of the present invention shown in FIG. 5 as portable device 30″ also comprises a keypad LED 45 that can emit light 52 that is used to illuminate the keypad user interface 44″. The processor 40 and memory 42 further function to trigger the keypad LED 45 to emit the light 52 based on the intensity and color of ambient light 32 received by the photodiode array 34″ with respect to user preferences. The keypad 45 is thus illuminated separately and independently from the LCD 48.

In contrast to the prior art, the present invention controls the illumination of a backlit LCD for variations in ambient light. The present invention illuminates the LCD backlight using a signal generated by a processor referencing user preferences. The effective result is that information displayed on the LCD is clearly visible to a user in any ambient lighting condition. By illuminating the LCD at only the desired time and intensity, the present invention also saves power. The present invention affords more convenience to a user of mobile phones or similar backlit-LCD products.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for controlling illumination of a backlight of a Liquid Crystal Display (LCD), the method comprising:
providing a light sensor capable of measuring an ambient light intensity to generate a corresponding measured ambient light intensity value;
providing a processing circuit for interpreting the measured ambient light intensity value;
providing a light source that is controllable by the processor;
providing an LCD device capable of being illuminated by the light source;
the processing circuit calculating a light source intensity value based on a desired apparent light source brightness value and the measured ambient light intensity value; and
the processor triggering the light source to emit light at a time-averaged intensity that corresponds to the calculated light source intensity value.

2. The method of claim 1 wherein the light source is a light emitting diode (LED), and the method further comprises:
the processor providing a driving duty cycle to the LED, the time-averaged intensity of the LED corresponding to the driving duty cycle; and
the processor adjusting the driving duty cycle according to the calculated light source intensity value.

3. The method of claim 1 wherein the light sensor is a photodiode.

4. The method of claim 3 further comprising providing a current to voltage converter and an analog to digital converter to process signals received from the photodiode to generate the measured ambient light intensity value.

5. The method of claim 4 wherein the LCD device is installed in a mobile phone or a personal digital assistant.

6. The method of claim 1 further comprising providing a user interface to enable a user to select one of a plurality of values for the desired apparent light source brightness value, and to enable a user to modify desired apparent light source brightness values.

7. The method of claim 6 further comprising providing a memory in which the desired apparent light source brightness value is stored, and the processor fetching the desired apparent light source brightness value from the memory to calculate the calculated light source intensity value.

8. The method of claim 7 further comprising providing a user interface light source controllable by the processor to illuminate the user interface with reference to information stored in the memory.

9. The method of claim 1 wherein the light sensor is a photodiode array, each photodiode sensitive to a unique spectrum of light, and the light source is an LED array, each LED capable of emitting light at a unique spectral frequency, the method further comprising:
the processor providing driving duty cycles to the LED array, the time-averaged intensity of each LED of the LED array corresponding to one of the driving duty cycles; and
the processor adjusting the driving duty cycles according to a plurality of calculated light source intensity values, one of the light source intensity values being used for each LED of the LED array.

10. A device for controlling the illumination of a backlight of a liquid crystal display (LCD), the device comprising:
a light sensor capable of measuring an ambient light intensity to generate a corresponding measured ambient light intensity value;
an LCD;
a light source for illuminating the LCD;
a memory comprising:
a selection program to select a desired apparent light source brightness value stored in a portion of the memory;
a calculation program to generate a light source intensity value based on the ambient light intensity value and the desired apparent light source brightness value; and
a control program to control the light source according to the light source intensity value; and
a processor for executing the programs of the memory.

11. The device of claim 10 wherein the light source is a light emitting diode (LED).

12. The device of claim 11 wherein the control program calculates a driving duty cycle for the LED, a time-averaged intensity of the LED corresponding to the driving duty cycle calculated by the control program.

13. The device of claim 10 wherein the memory further comprises a plurality of desired apparent light source brightness value relationships stored in a nonvolatile portion of the memory.

14. The device of claim 13 further comprising a user interface that allows a user to select a desired apparent light source brightness value according to the selection program and further to modify desired apparent light source brightness values.

15. The device of claim 10 wherein the light source intensity value is set high when the ambient light intensity value is low and the desired apparent light source brightness value is high, and the light source intensity value is set low when the ambient light intensity value is high and the desired apparent light source brightness value is low.

16. The device of claim 10 wherein the light sensor is a photodiode.

17. The device of claim 16 further comprising a current to voltage converter and an analog to digital converter to process signals received from the photodiode to generate the measured ambient light intensity value.

18. The device of claim 17 wherein the device is installed in a mobile phone or a personal digital assistant.

19. The device of claim 10 further comprising a light source controllable by the processor for illuminating a keypad.
